(19) United States
(12) Patent Application Publication
(10) Pub. No.: US 2017/0208838 A1
(43) Pub. Date: Jul. 27, 2017

(54) LONG-LASTING PET FOOD

(71) Applicant: Mars, Incorporated, McLean, VA (US)

(72) Inventors: Carolin Welz, Verden (DE); Jörg Nitschke, Verden (DE)

(73) Assignee: Mars, Incorporated, McLean, VA (US)

(21) Appl. No.: 15/328,383

(22) PCT Filed: Jul. 24, 2015
(86) PCT No.: PCT/EP2015/067087

§ 371 Date: Jan. 23, 2017

(30) Foreign Application Priority Data
Jul. 24, 2014 (DE) 10 2014 110 475.7
Jul. 24, 2014 (DE) 10 2014 110 477.3

(51) Int. Cl. A23K 40/30; A23K 20/111; A23K 20/121; A23K 20/179; A23K 20/158; A23K 20/163; A23K 20/20; A23K 50/42; A23K 50/45; A23K 20/147

(52) U.S. Cl. CPC A23K 40/30; A23K 50/45; A23K 20/111; A23K 20/121; A23K 20/147; A23K 20/158; A23K 20/163; A23K 20/30; A23K 50/42; A23K 20/179

(57) ABSTRACT

The present disclosure provides a pet food, comprising: a) a pet food core, b) one or more active layers surrounding all, or a portion of, the pet food core, and c) an outer layer at least partially surrounding the active layer, wherein the outer layer comprises a fat and/or a pallatant, wherein the active layer may comprise one or more of an antioxidant compound and a pro-oxidant compound. The active layer may be enriched with the pro-oxidant mineral compared to the pet food core, and/or the pet food core and the active layer may have different total concentrations of antioxidant compounds and/or the pet food core and the active layer may comprise different antioxidant compounds and/or the same antioxidant compounds in different concentrations.

### RELATED APPLICATIONS

This application claims priority from German Patent Application No. 102014110475.7, which was filed on 24 Jul. 2014, and from German Patent Application No. 102014110477.3, which was filed 24 Jul. 2014.

### TECHNICAL FIELD

The present disclosure relates to a long-lasting pet food that is coated with one or more layers of edible film(s).

### BACKGROUND

In the field of foodstuffs, especially in the field of pet foods, it is currently a problem that the storage stability of the foodstuffs is limited by the oxidation of fats contained in the foodstuffs, especially unsaturated fats. Oxidation processes of this kind both accelerate the spoiling process of the foodstuffs and impair their flavour significantly.

One possibility known from the state of the art for preventing these oxidation processes in foodstuffs is to provide the foodstuffs with a coat. The barrier properties of edible coatings of this kind are well-known from the state of the art. In particular, coatings made from mixtures of whey protein isolate/pea starch/carnauba wax or sodium caseinate/bees' wax have been described as suitable for reducing the oxidation of fat (Mehyar et al., Journal of Food Science, 2012, 77(2), 52-59, Fabra et al., Journal of Food Engineering, 2012, 109, 372-379).

The known measures nevertheless remain inadequate, especially in preventing the oxidation of fat to such an extent that it would become possible to use the treated foodstuffs as “non-perishable”, long-lasting foodstuffs or foodstuffs with an extended shelf-life.

### BRIEF SUMMARY

This summary describes several embodiments of the presently-disclosed subject matter, and it lists variations and permutations of the invention(s) provided herein. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this summary or not. To avoid excessive repetition, this summary does not list or suggest all possible combinations of features.

It is therefore an object of the present application to provide coatings for foodstuffs, especially for pet food, which overcome the disadvantages of the state of the art and in particular lead to an improvement in the stability, especially the storage stability, of the pet food. It is also intended to provide coated foodstuffs which, despite the coating, exhibit unchanged or even improved flavour characteristics and/or whose nutritional value is not reduced by the coating, but is preferably even improved.

In one embodiment, this problem is solved in accordance with the present disclosure by a pet food comprising: a) a pet food core, b) an active layer surrounding the pet food core, wherein the active layer comprises a pro-oxidant mineral, and c) an outer layer surrounding the active layer, wherein the outer layer comprises a fat and/or a palatant, and wherein the active layer is enriched with the pro-oxidant mineral compared to the pet food core.

In another embodiment, the problem is solved in accordance with the present application by a pet food comprising: a) a pet food core, b) an active layer surrounding the pet food core, wherein the active layer comprises an antioxidant compound, and c) an outer layer surrounding the active layer, wherein the outer layer comprises a fat and/or a palatant, wherein the pet food core and the active layer have different total concentrations of antioxidant compounds and/or the pet food core and the active layer comprise different antioxidant compounds and/or the same antioxidant compounds in different concentrations.

In a further embodiment, the problem is solved in accordance with the present application by a pet food comprising: a) a pet food core; b) at least one active layer that is at least partially coated on the pet food core, wherein the at least one active layer comprises one or more of: soy protein hydrolysate, pea starch, pork fat, lecithin, glycerol and water; and c) an outer layer that at least partially surrounds the at least one active layer, wherein the outer layer comprises a fat and/or a palatant.

In a still further embodiment, the problem is solved in accordance with the present application by a pet food comprising: a) a pet food core; b) at least one active layer that is at least partially coated on the pet food core, wherein the at least one active layer comprises one or more of: whey protein hydrolysate, pea starch, carnauba wax, glycerol, soya lecithin, and a pro-oxidant; and c) an outer layer that at least partially surrounds the at least one active layer, wherein the outer layer comprises a fat and/or a palatant.

In yet another embodiment, the problem is solved in accordance with the present application by a method of increasing the shelf life of a pet food having a pet food core by coating the pet food core with: (i) a first edible film, wherein the first edible film comprises at least one antioxidant; and (ii) at least one outer layer, wherein the other layer comprises at least one fat or at least one palatant. The pet food core is additionally coated with a second edible film, wherein the second edible film comprises at least one pro-oxidant, in certain embodiments. And in some embodiments, each of the edible film(s) and the at least one outer layer at least partially surrounds the pet food core. And in certain embodiments, at least one active layer or edible film(s) of the present disclosure further comprise an amount of curcumin.

### DESCRIPTION OF THE FIGURES

FIG. 1 is a schematic illustration of a pet food of the present application.

FIG. 2 is a graphical illustration of the development of lipid oxidation for a pet food of the present application with an active layer that has been enriched with Cu(II) sulphate, as compared to a pet food having no active layer.

FIG. 3 shows a graphical illustration of the development of secondary oxidation products for a pet food according to the present disclosure with an active layer that has been enriched with Cu(II) sulphate, as compared to a pet food with no active layer.

FIG. 4 shows results of dog feeding tests experiments for a reference product and a pet food in accordance with the present disclosure that has an active layer which has been enriched with Cu(II) sulphate.

FIG. 5 shows the results of a detailed difference analysis for the results of the dog feeding tests according to FIG. 4.

FIG. 6 shows results of dog feeding tests for a) an edible layer itself and b) the same edible layer additionally comprising ascorbic acid.

FIG. 7 shows a graphical illustration of the development of lipid oxidation for a pet food of the present disclosure in which ascorbic acid has been enriched in the active layer as an antioxidant compound.

FIG. 8 shows results of dog feeding experiments for a reference product and a pet food in accordance with the present disclosure in which ascorbic acid has been enriched in the active layer as an antioxidant compound instead.

FIG. 9 shows the results of a detailed difference analysis for the results of the feeding tests according to FIG. 8.

FIG. 10 shows a graphical illustration of the development of lipid oxidation for a pet food of the present disclosure, wherein the pet food is coated with an edible film comprising soy protein hydrolysate, pea starch, pork fat, lecithin, glycerol and water.

### DETAILED DESCRIPTION OF EXEMPLARY EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

The presently-disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure.

For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently-disclosed subject matter.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±50%, in some embodiments ±40%, in some embodiments ±30%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

In some embodiments of the present application, it is preferred in this connection that the pet food core is a dry food core, a semi-moist pet food core or a care & treat product. Indeed, the pet food core may comprise, for example, a chew, a biscuit, a kibble, a meat and/or meat-analogue and/or meat-substitute product, a tablet, a loaf, a chunk and/or the like.

According to the present disclosure, dry food cores herein have a water content of about 5 to 10%, with a water activity of about 0.54-0.65. Semi-moist pet food cores of the present disclosure have a water content of about 15 to 25% with a water activity of about 0.7-0.83.

Further, in certain embodiments according to the present application, “care & treat products” is intended to mean products which do not have a complete nutrient composition, i.e. they are not complete food products. In contrast to these, the dry and semi-dry products referred to are preferably complete food products. And some care & treat products of the present disclosure are characterised by the fact that they have an additional functional property, such as tooth-cleaning properties, rewards, special flavour etc.

For the purposes of the present application, “pets” are intended to mean animals (as distinct from farm animals) which are usually kept in people's homes and have no agricultural use, such as dogs, cats, guinea pigs, hamsters, etc. In particular, the term “pet” in accordance with the present application is intended to comprise dogs and cats, particularly preferably dogs.

For the purposes of the present application, a pet food is a foodstuff which is especially and preferably, though not exclusively, suitable for feeding pets. A pet food is deemed to be suitable in this connection if it contains substantially all or at least a major part of the macronu-trients and micronutrients that enable long-term and healthy feeding of the animal. A pet food in accordance with the invention is also preferably characterised by the fact that, because of its flavour characteristics, its aroma, its visual characteristics etc., it is accepted by pets, i.e. they eat it with preference.

For the purposes of the present application, a dry food is in particular intended to be understood to mean a food which is produced from dry foodstuffs, or individual foodstuffs (ingredients) or non-dry components, such as meat emulsions, by drying. A dry food in accordance with the present application is preferably characterised by the fact that it is present in solid, substantially uniform pieces, is easy to portion as a result, and, when kept in a cool, dry place, can be stored for a lengthy period. The residual water content of the dry food can be adjusted by drying and should preferably not exceed 14%, based on the total weight of the dry food.

For the purposes of the present application, the term “pet food core” is intended to be understood as meaning that a core (piece, pellet, biscuit, croquette, etc.) of a pet food is prepared, and that piece of pet food serves as a core and is coated.

For the purposes of the present application, an “active layer” and/or “edible film” is intended to be understood as a coating. In some embodiments, and active layer is preferably applied directly onto a pet food core. And in certain embodiments, the active layer comprises at least one pro-oxidant mineral or at least one antioxidant. It is particularly preferably contemplated that the active layer surrounds the pet food core completely. According to the embodiments of the invention(s) of the present application, it may, however, likewise be contemplated that the active layer does not surround the pet food core completely, but only partially, preferably by 50%, particularly preferably 70%, in addition preferably 80%, especially preferably 90%, and also preferably 95%, based on the total surface area of the pet food core.

The term “surround” here is intended to be understood in accordance with the present disclosure as meaning that the active layer forms a covering around the pet food core. It may be contemplated in this connection that the layer is applied directly onto the pet food core. It may likewise be contemplated that the active layer is not or only partially in direct contact with the pet food core in some embodiments.

A pro-oxidant for the purposes of the present application is intended to be understood to mean a compound that is capable of generating reactive oxygen species and/or of inhibiting antioxidant systems. In particular, pro-oxidants are compounds, such as heavy metal salts (e.g. copper or iron salts) or compounds containing heavy metals (e.g. haemoglobin), which have an accelerating effect on the kinetics of lipid oxidation by: a) generating fatty acid and fatty acid hydroperoxide radicals by means of an electron transfer and/or b) catalysing the homolytic degradation of lipid hydroperoxides via a single-electron redox reaction by forming a metal-oxygen or metal-hydroperoxide transition complex (compare Frankel et al., Lipid Oxidation, 2nd Edition, 2005, The Oily Press).

According to the present application, minerals are preferably intended to be understood as meaning metal salts. The term metal salt for the purposes of the application comprises any combinations of one or more charged, preferably positively charged, metal ions and one or more counter-ions, preferably anions. Possible anions in this connection are fluoride, chloride, bromide, iodide, nitrate, sulphate, phosphate, etc. Similarly comprised in accordance with the application are also organic anions, such as carbonate, e.g. acetate, stearate or the like, sulphonate etc. Other preferred anions in this connection are citrate or lactate, for example. Chelate complexes of those metal ions, such as EDTA complexes, are likewise intended to be regarded as preferred minerals, or metal salts, in accordance with the present application.

For the purposes of the present application, a substance is deemed to be enriched if it is present in one region of the pet food in a higher concentration than in another region. It is preferably contemplated that the enriched substance is added to a region, preferably to a layer, such as an active layer, during manufacture, whereas there is no addition in another region, preferably in the core, which is surrounded by the layer.

According to the present application, it is particularly preferred that, in the pet food of the application, the pet food core contains substantially no pro-oxidant mineral. The expression “substantially no” is intended to be understood in this connection as meaning that, in the manufacture of the pet food core, the addition of the pro-oxidant material is dispensed with and, depending on the manufacturing process, measures are adopted which restrict the presence of the pro-oxidant mineral in the pet food core to a minimum, so that the pro-oxidant mineral is merely present in the pet food core in quantities that cannot be prevented by technical measures. It is particularly preferably contemplated in this connection that the pro-oxidant mineral in the active layer has a concentration that is higher by at least a factor of 2 compared to the pet food core, preferably a concentration that is higher by at least a factor of 3.

According to the present application, it is contemplated that both the pet food core and the active layer are edible, meaning that at least while being eaten as food and during digestion, they are not harmful and that they preferably have a nutritional value.

For the purposes of the present application, “fats” are intended to be understood in particular as solid, semi-solid, liquid, more or less viscous, non-polar products of the plant or animal body, preferably glycerol esters of the fatty acids.

The term palatant for the purposes of the present application is intended to be understood broadly, as known in the art. A palatant in this connection is a compound contained in a foodstuff which makes a substantial contribution to the flavour of the foodstuff. Palatants in this context have a pronounced flavour of their own.

In certain embodiments of the present application, a preferred palatant in this connection is a preparation of offal from various species of animals, especially poultry, which thanks to the special manufacturing process develops flavours and aromas that are particularly attractive both to dogs and to cats (maleate products). According to the present application, it is particularly preferably contemplated that this preparation should be applied to the outermost surface of the products.

Further, in some embodiments, it is preferably contemplated that the pro-oxidant mineral comprises a pro-oxidant metal and/or pro-oxidant metal ions, preferably the pro-oxidant mineral comprises copper, iron, cobalt, manganese, their salts or mixtures thereof, particularly preferably that the pro-oxidant mineral comprises Cu(I), Cu(II), Fe(II), Fe(III) or Co(III) ions or mixtures thereof, especially preferably that the pro-oxidant mineral comprises Cu(II) ions. Copper(II) sulphate or copper(II) proteinate are very particularly preferred as the pro-oxidant mineral in certain embodiments.

Meanwhile, in other embodiments, the active layer may be substantially free of a pro-oxidant mineral, such as copper. Indeed, the present application contemplates certain embodiments wherein the active layer contains less than 0.0001% (w/w) of a pro-oxidant mineral in the active layer, based on the total weight of the pet food. Conversely, it is preferred, in some embodiments, that the pro-oxidant mineral is contained in the active layer in an amount of 0.0001-0.011% (w/w), preferably 0.0001-0.01% (w/w), even more preferably 0.0005-0.005% (w/w), and most preferably 0.0011% (w/w), based on the total weight of the pet food.

In some embodiments, it is preferred that the active layer further comprises a protein compound, a carbohydrate compound, a fat compound and/or a wax, a plasticiser, an emulsifier or mixtures thereof. In certain preferred embodiments, it may be contemplated that contained in the active layer are a protein compound in an amount of 0.015-0.6% (w/w), a carbohydrate compound in an amount of 0.015-0.6% (w/w), a fat compound and/or a wax in an amount of 0.015-0.6 (w/w), a plasticiser in an amount of 0.015-1.2% (w/w) and an emulsifier in an amount of 0.003-0.6% (w/w), based on the total weight of the pet food.

In certain embodiments, the preferred protein compounds for inclusion in the active layer may comprise one or more of: animal or vegetable protein, protein hydrolysate, whey protein hydrolysate, zein, caseinate, pea protein isolate, feather protein isolate, blood plasma isolate or poultry protein isolate, especially preferably whey protein isolate, and/or mixtures thereof.

Likewise, in certain embodiments, the preferred carbohydrates of the present disclosure include various starches, especially preferably pea starch, dextrin, gum Arabica, mannan, carrageenan, pectin, alginate, chitosan, and/or any mixture thereof.

Additionally, preferred lipids of the present disclosure include animal or vegetable fats and oils, waxes, especially carnauba wax, beeswax, beef tallow, pork lard, candelilla wax, coconut oil, coprah oil, beef suet, poultry fat, lard, candle wax, palm stearin and/or any mixture thereof.

A plasticiser for the purposes of the present application is intended to be understood to mean a substance which is added to a mixture in order to make it softer, more flexible, more supple and elastic. According to the present application, it is contemplated that the plasticiser is an edible plasticiser. Glycerol is contemplated as a particularly preferred plasticiser.

The compositions and/or foods of the present application may further comprise an emulsifier, which is an additive that serves to blend and stabilise two liquids that are not miscible, such as oil and water, into a finely dispersed mixture, known as an emulsion. A particularly preferred emulsifier according to the present application is lecithin.

According to the present application, it may be contemplated that both a single compound and a mixture of different compounds of the various species, such as two or more protein compounds, are present in the active layer.

Moreover, the pet food of the present application can be produced in a simple manner using methods known from the state of the art. For this purpose, an exemplary method is to apply a coating mixture containing the ingredients of the invention(s), especially: (i) a pro-oxidant mineral and water and/or (ii) an antioxidant compound and water, onto the pet food core used. After that, the coating mixture applied is dried by conventional methods known from the state of the art, such as by heating, freeze-drying, drying by means of a current of hot air etc. According to the present application, it is likewise contemplated that the pet food of the present application is obtained by merely partially coating a pet food core with one or more active layers.

“At least partially coated” is intended to be understood in accordance with the present application as meaning a core having at least one surface that is not completely surrounded and/or coated by at least one layer. Likewise, a core is at least partially coated if the core is already completely surrounded and/or coated, but at least one layer has not yet reached its complete, maximum layer thickness.

The problem underlying the invention(s) of the present application is also solved by a use of the pet food of the invention(s) as a long-lasting pet food. A long-lasting pet food for the purposes of the present application is a pet food whose shelf life is extended compared to non-long-life foods of the same or similar kind.

It has surprisingly been found that a pet food in accordance with the present application solves the problem in that its shelf life and storage stability are improved compared to conventional pet foods known from the state of the art and that it is in additionally characterised by enhanced acceptance by the addressees, which can be attributed to improved flavour and aroma properties.

Furthermore, the inventors of the present disclosure have found that multi-layer coatings of dry food consisting of one or more edible films/active layers and fat/palatant can lead to an improvement in an oxygen barrier and also that positive effects with regard to the flavour, which are known for fat/palatant layers and the oxygen barrier properties, can surprisingly be combined synergistically. The improved barrier properties of edible layers thus results in an unexpectedly great potential for reducing lipid oxidation in dry pet foods.

In certain embodiments, the concept underlying the present application intends that, especially from the nutritional point of view, pro-oxidant minerals, such as copper and copper ions, are removed and kept away from the pet food core by means of segregating the copper and/or copper ions from the pet food core. In some embodiments, copper and/or copper ions, such as the copper and/or copper ions that are separated from the pet food core, are concentrated in one or more edible films. Meanwhile, in certain embodiments, the pet food(s) of the present disclosure may comprise particular unsaturated fatty acids that are spatially separated from pro-oxidant metal ions by their respective inclusion in either the pet food core or the one or more active layers.

It is to be understood that separation and/or segregation of an ingredient of a pet food from one or more other ingredients of the pet food may be accomplished by including that ingredient in one or more distinct areas of the pet food, such as, for example, a pet food core, a first active layer, a second active layer, a third active layer, etc. Including an ingredient in one or more distinct areas of the pet food may comprise concentrating that ingredient in the one or more distinct areas of the pet food and/or adding that ingredient to only one or more distinct areas of the pet food.

Further, it is to be understood that the separation and/or segregation of a first ingredient from a second ingredient is accomplished, in some embodiments, by including the first ingredient in a first distinct area of the pet food, such as the pet food core, and including the second ingredient in a second distinct area of the pet food, such as a first active layer. Moreover, the present application contemplates certain embodiments wherein a pet food comprises one or more active layers and further wherein each active layer may include one or more pro-oxidant and/or antioxidants and still further wherein each active layer is considered spatially separate and/or distinct from any other active layer(s) and/or from the pet food core. And in some embodiments, one or more of the pet food core and/or active layers may be free or substantially free of any pro-oxidant or antioxidant contemplated herein.

And in some embodiments, the concept underlying the present application intends that, especially from a nutritional point of view, an antioxidant compound, such as ascorbic acid, is removed and kept away from the pet food core and concentrated in an edible layer. In certain embodiments in particular, one or more unsaturated fatty acids and one or more antioxidant compounds are spatially separated within a pet food. And in further embodiments, the present application provides a pet food product comprising: (i) a pet food core, (ii) a first edible film and/or first active layer comprising a pro-oxidant, (iii) a second edible film and/or second active layer comprising an antioxidant, and (iv) a third edible film and/or third active layer comprising a fat and/or a palatant, wherein each of the active layers is applied may be applied in a separate step, wherein each of the active layers is considered spatially distinct and/or separate from the other layers and/or the pet food core, and further wherein each of the core and the active layer(s) is adjacent to at least one other of the core and the additional active layer(s).

In certain embodiments, it has surprisingly been found that the spatial separation of a pro-oxidant metal or metal ion, such as copper, from a pet food core leads to a distinct improvement in product stability. Experiments in which the eating behaviour of dogs was investigated, have shown that, in certain embodiments, when a pro-oxidant mineral is concentrated in a layer surrounding the pet food core in this way, it does not have a negative influence on the tastiness of the food.

Further, it has surprisingly been found that, in certain embodiments, the spatial separation of an antioxidant compound from a pet food core leads to a distinct improvement in product stability. Experiments in which the eating behaviour of dogs was investigated, have shown that when an antioxidant compound is concentrated in a layer surrounding the pet food core in this way, it does not have a negative influence on the tastiness of the food. On the contrary, it was surprisingly even found that, in certain embodiments, an active layer containing an antioxidant, such as ascorbic acid, even has a distinctly positive influence on the tastiness of the pet food.

Further features and advantages of the compositions and methods of the present application will become clear from the present detailed description of preferred embodiments, especially against the background of the worked embodiments and Figures.

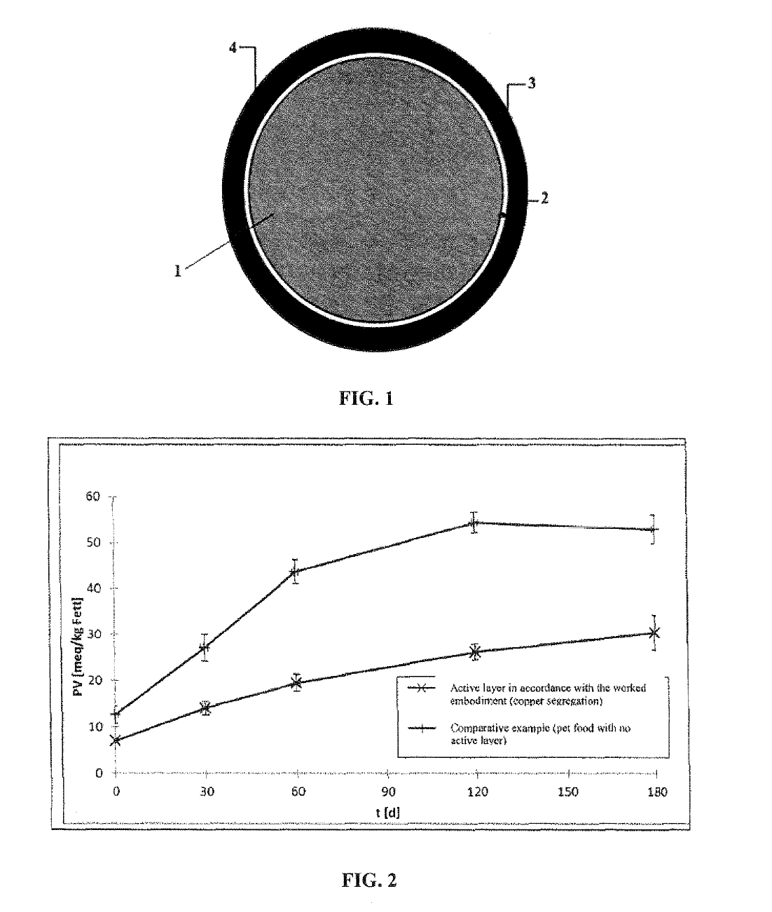

FIG. 1 is a schematic illustration of the pet food of the present application. Indeed, FIG. 1 shows a pet food core 1 that is coated directly with one or more active layers 2,4. In some embodiments, the one or more active layers 2,4 contains one or more pro-oxidant minerals, such as copper sulphate, or one or more antioxidants, such as ascorbic acid. In some embodiments, a first active layer, 2 or 4, may comprise a pro-oxidant mineral, such as copper sulfate, and a second active layer, 2 or 4, may comprise an antioxidant, such as ascorbic acid. Additionally, as shown in FIG. 1, the active layers may be coated with an outer layer 3, comprising one or more fats and/or one or more palatants, which is applied to the one or more active layers 2,4.

FIG. 2 shows a graphical illustration of the development of lipid oxidation for a pet food of the invention with an active layer which has been enriched with Cu(II) sulphate, as compared to a pet food having no active layer.

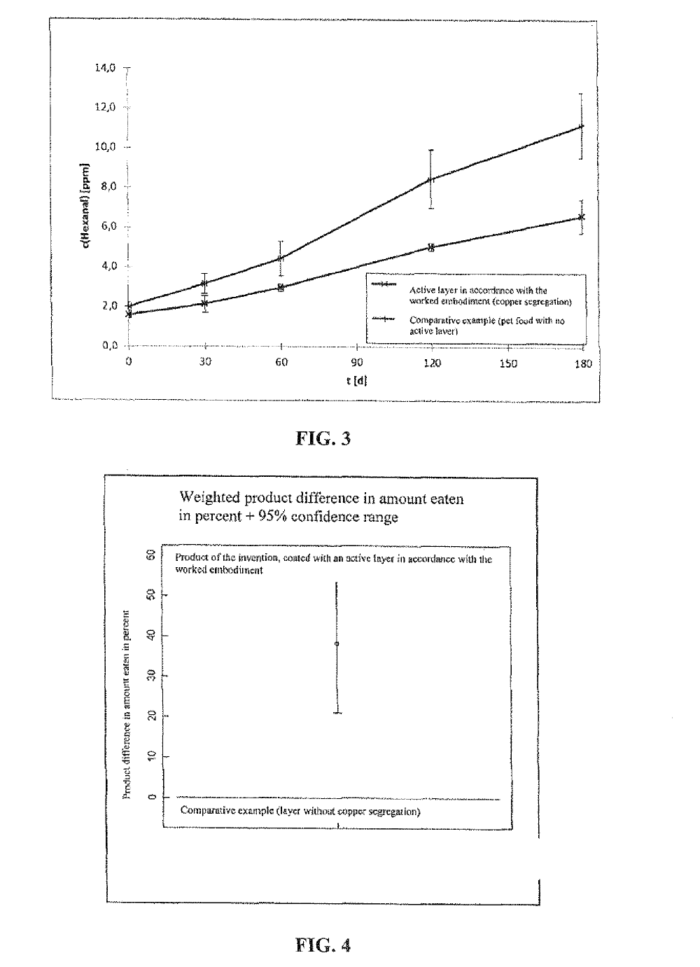

FIG. 3 shows a graphical illustration of the development of secondary oxidation products for a pet food according to the present disclosure with an active layer that has been enriched with Cu(II) sulphate, as compared to a pet food with no active layer.

FIG. 4 shows results of dog feeding tests experiments for a reference product and a pet food in accordance with the present disclosure that has an active layer which has been enriched with Cu(II) sulphate.

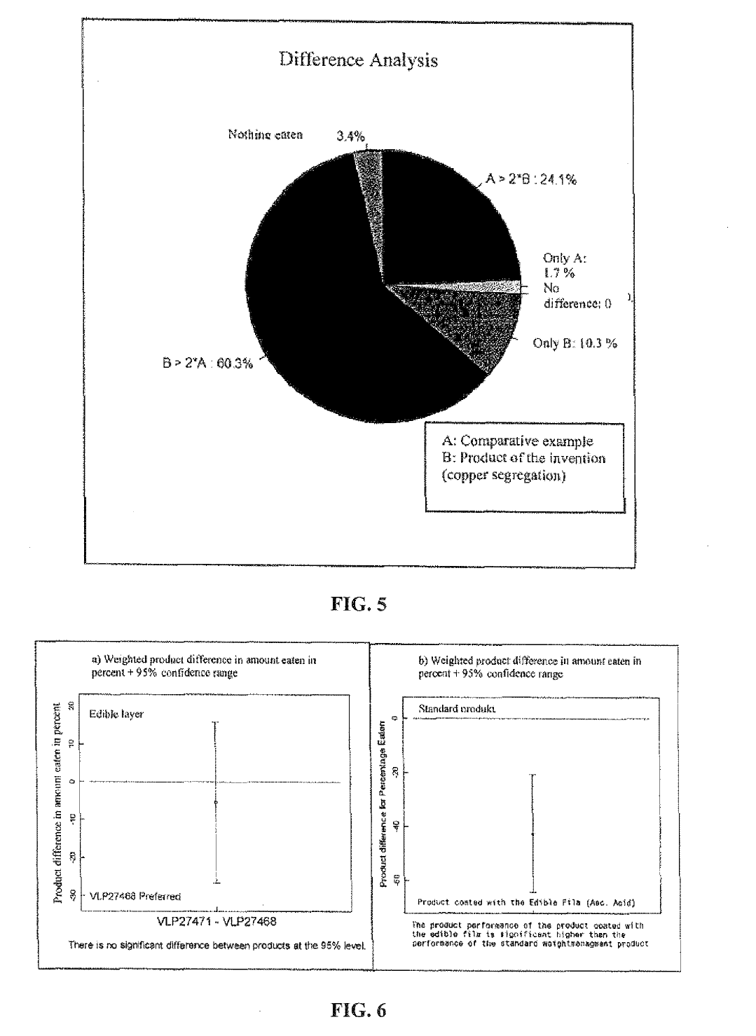

FIG. 5 shows the results of a detailed difference analysis for the results of the dog feeding tests according to FIG. 4.

FIG. 6 shows results of dog feeding tests for a) an edible layer itself and b) the same edible layer additionally comprising ascorbic acid.

FIG. 7 shows a graphical illustration of the development of lipid oxidation for a pet food of the present disclosure in which ascorbic acid has been enriched in the active layer as an antioxidant compound.

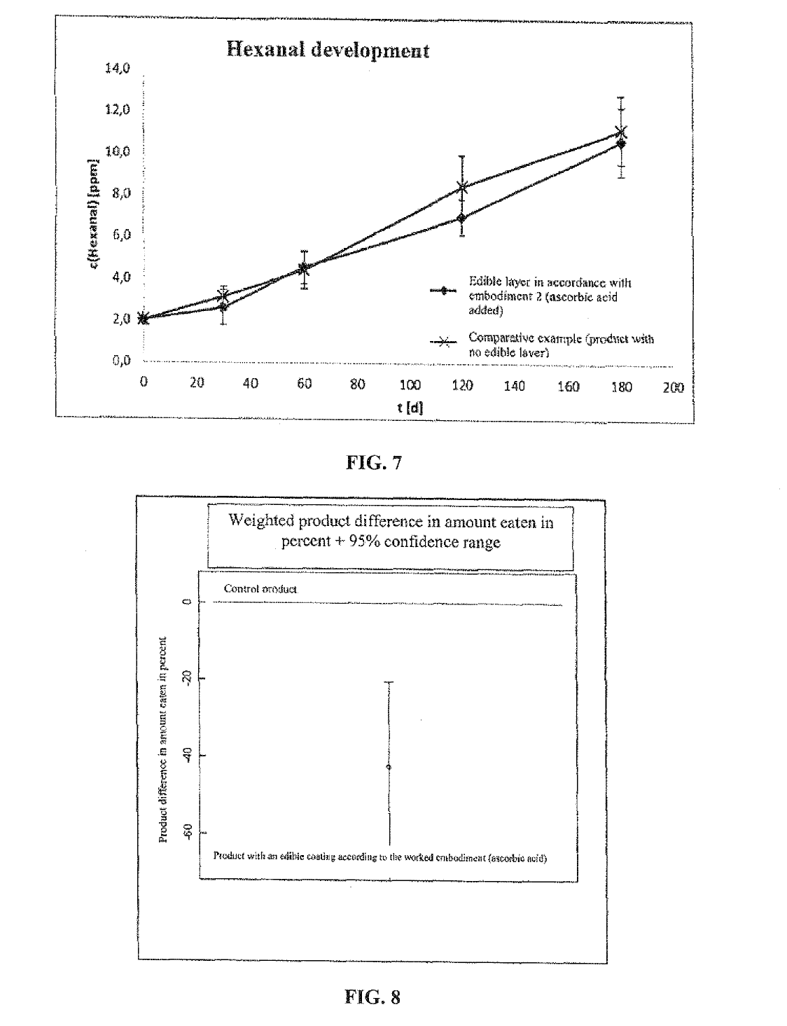

FIG. 8 shows results of dog feeding experiments for a reference product and a pet food in accordance with the present disclosure in which ascorbic acid has been enriched in the active layer as an antioxidant compound instead.

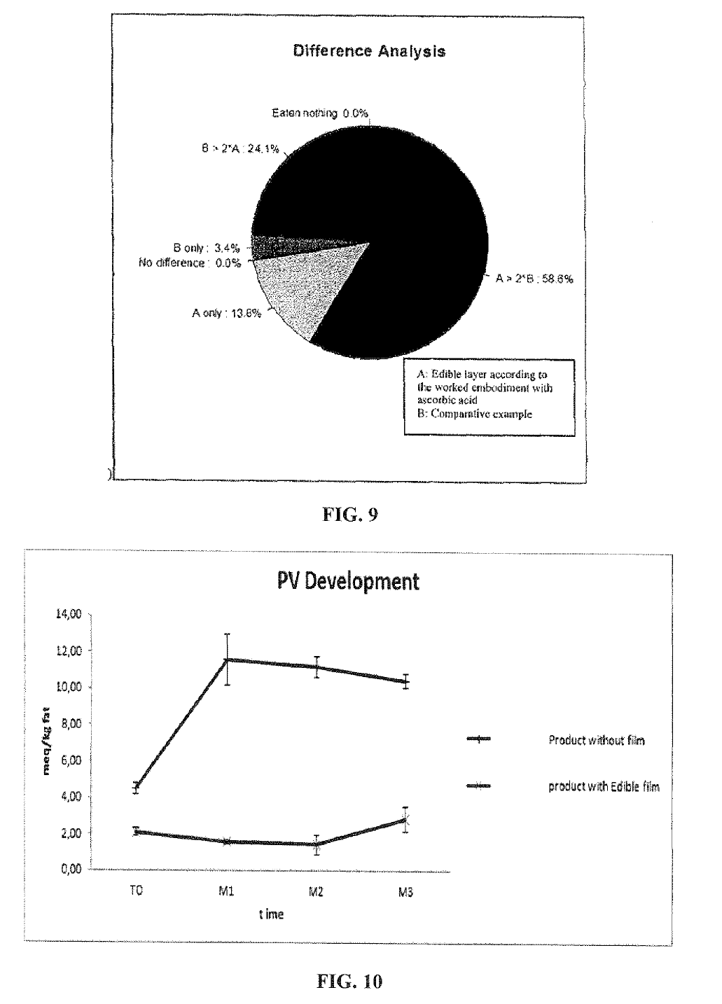

FIG. 9 shows the results of a detailed difference analysis for the results of the feeding tests according to FIG. 8.

FIG. 10 shows a graphical illustration of the development of lipid oxidation for a pet food of the present disclosure, wherein the pet food is coated with an edible film comprising soy protein hydrolysate, pea starch, pork fat, lecithin, glycerol and water.

### First Worked Embodiment

A known dry food (Dry Cat & Dog, C & T, Semimoist Kibble) was used as the pet food core. That dry food contained (based on the dry mass) 22% protein, 45% carbohydrates, 12% fat, 2% raw fibre and 0.2-0.8% water activity (active water) and also 8% ash.

The pet food cores prepared in this way were coated with a 3-12% solution to produce edible layers (coating mixture), based on the dry mass. The coating mixture contained a protein source, a carbohydrate source, a wax or lipid, a plasticiser and an emulsifier. In addition, copper salts were added. The edible coating mixture used was based on water as a solvent.

The coating mixture was produced by adding whey protein isolate, pea starch, lecithin and glycerol to water. The mixture was then homogenised at 8,500 revolutions per minute for 15 minutes (L5M, Silverson Machines Ltd., Waterside, England). The solution obtained was filled up to 1 litre. After that, the solution was heated to 90 to 100° C. Carnauba wax and copper sulphate pentahydrate were added to the solution, and the emulsion was heated again. Following that, the solution was blended with a homogeniser at 8,500 revolutions per minute for two minutes.

In a specific example, a coating mixture was used which contained (in percent by weight, based on the total volume of the coating mixture) 2.5% whey protein isolate, 2.5% pea starch, 2.5% carnauba wax, 7.5% glycerol, 1.3% soya lecithin and 0.84% copper(II) sul-phate.

The coating mixture was sprayed onto the pet food cores, using conventional coating tools known from the state of the art. After the coating step, an active layer was produced from the coating in the form of a solid film. In the present case, a Forberg F50 batch coater was used in production. That is a paddle coating apparatus which sprays the solution through a vacuum pumping system. For drying purposes, a belt dryer (Aeroglide) was used. The product was dried to a moisture content of 7%. The temperature range used was 35° C. to 50° C., the belt speed being set depending on the moisture of the undried pet food.

In general, the spraying/coating time in this connection can depend on the choice of coating tool and the level of the coating used. The coated products with the edible films were dried to a final moisture content of 5 to 9%. The temperatures and drying times used were also depen-dent on the nature of the tools/quantities used.

### Second Worked Embodiment

A known dry food (Dry Cat & Dog, C & T, Semimoist Kibble) was used as the pet food core. That dry food contained (based on the dry mass) 22% protein, 45% carbohydrates, 12% fat, 2% raw fibre and 0.2-0.8% water activity (active water) and also 8% ash.

The pet food cores prepared in this way were coated with a 3-12% solution to produce edible layers (coating mixture), based on the dry mass. The coating mixture contained a protein source, a carbohydrate source, a wax or lipid, a plasticiser and an emulsifier. In addition, ascorbic acid was added. The edible coating mixture used was based on water as a solvent.

The coating mixture was produced by adding whey protein isolate, pea starch, lecithin and glycerol to water. The mixture was then homogenised at 8,500 revolutions per minute for 15 minutes (L5M, Silverson Machines Ltd., Waterside, England). The solution obtained was filled up to 1 litre. After that, the solution was heated to 90 to 100° C. Carnauba wax and ascorbic acid were added to the solution, and the emulsion was heated again. Following that, the solution was blended with a homogeniser (see above) at 8,500 revolutions per minute for two minutes.

In a specific example, a coating mixture was used which contained (in percent by weight, based on the total volume of the coating mixture) 2.5% whey protein isolate, 2.5% pea starch, 2.5% carnauba wax, 7.5% glycerol, 1.3% soya lecithin and 3.5% ascorbic acid.

The coating mixture was sprayed onto the pet food cores, using conventional coating tools known from the state of the art. After the coating step, an active layer was produced from the coating in the form of a solid film. In the present case, a Forberg F50 batch coater was used in production. That is a paddle coating apparatus which sprays the solution through a vacuum pumping system. For drying purposes, a belt dryer (Aeroglide) was used. The product was dried to a moisture content of 7%. The temperature range used was 35° C. to 50° C., the belt speed being set as a function of the moisture of the undried pet food.

In general, the spraying/coating time in this connection can depend on the choice of coating tool and the level of the coating used. The coated products with the edible films were dried to a final moisture content of 5 to 9%. The temperatures and drying times used were also depen-dent on the nature of the tools/quantities used.

### Discussion

The pet foods of the present disclosure obtained in these ways were examined to determine their oxidation stability and flavour properties, and then they were compared to coated animal foods not in accordance with the present application but known from the state of the art.

Lipid oxidation is one of the main parameters limiting the storage stability of dry animal food. Unsaturated fatty acids which are added to the dry animal food for nutritional reasons are highly susceptible to oxidation. The oxidation of those fatty acids leads to a loss of those compounds, which are essential to nutrition.

According to certain embodiments of the present disclosure, it is particularly preferred that, in the pet food of the present application, the pet food core contains substantially no additional antioxidant compounds. The expression “substantially no additional” is intended to be understood in this connection as meaning that, in the manufacture of the pet food core, the addition of antioxidant compounds is dispensed with and, depending on the manufacturing process, measures are adopted which restrict the presence of antioxidant compounds in the pet food core to a minimum, so that the antioxidant compounds are merely present in the pet food core in quantities that cannot be prevented by technical measures.

According to the present application, it is contemplated that both the pet food core and the active layer are edible, i.e. at least while being eaten as food and during digestion, they are not harmful, preferably having a nutritional value. An “edible film” of the present disclosure may comprise one or more edible active layers, whereas a “pet food” of the present disclosure may comprise a pet food core that is coated at least in part by an edible film, as described hereinabove.

It is preferably contemplated that, in certain embodiments, an antioxidant and/or antioxidant compound of the present application is ascorbic acid, ascorbic acid ester, preferably ascorbyl palmitate, tocopherol (α,β,γ and δ-tocopherol), Trolox, propyl galate, resveratrol, butyl hydroxyanisol, tert-butyl hydroxytoluene, vegetable polyphenols, preferably flavonoids, anthocyanins, proanthocyanidins, caffeic acid, chlorogenic acid, ferulic acid, lycopenes, carotenoids and/or mixtures thereof.

It is further contemplated that an antioxidant compound for the purposes of the present application is a chemical compound which, in a targeted manner, prevents the unwanted oxidation of other substances. According to the invention, ascorbic acid (vitamin C) is particularly preferred as an antioxidant compound.

It is likewise preferred that the pet food core is a dry food core, a semi-moist pet food core or a care & treat product, as known in the art and/or as defined herein.

For the purposes of the present application, “fats” are intended to be understood in particular as solid, semi-solid, liquid, more or less viscous, non-polar products of the plant or animal body, preferably glycerol esters of the fatty acids.

The term palatant for the purposes of the present application is intended to be understood broadly. A palatant in this connection is a compound contained in a foodstuff which makes a substantial contribution to the flavour of the foodstuff. Palatants in this context have a pronounced flavour of their own.

It is likewise preferably contemplated that the antioxidant compound is contained in the active layer in an amount of 0.03-0.3% (w/w), preferably 0.06-0.27% (w/w), even more preferably 0.15-0.24% (w/w), especially preferably 0.192-0.222% (w/w), based on the total weight of the pet food.

Additionally, it is contemplated that one or more of the edible film(s) and/or active layer(s) of the present disclosure may comprise partially hydrogenated plant oil, such as soybean oil, corn oil, cocoa butter, cottonseed oil, butter oil, palm kernel oil, canola oil, rapeseed oil, palm oil, and/or mixtures thereof. And in some embodiments, an edible film and/or active layer of the present disclosure may comprise one or more of calcium pantothenate, pantothenic acid, biotin, thiamine mononitrate (source of vitamin BI),vitamin BI2 supplement, niacin, riboflavin supplement (source of vitamin B2), inositol, taurine, pyridoxine hydrochloride(source of vitamin B6), vitamin D3 supplement, folic acid, and/or any mixture thereof.

In further embodiments, an edible film and/or active layer of the present disclosure may comprise one or more of: curcumines, turmeric extract, caffeic extract, blueberry extract, grape extract, rosemary extract, tea extract, reservatrol, jasmine extract, green tea extract, peanut skin extract, other herb and fruit extracts, and/or any mixture thereof. And in some embodiments, an edible film and/or active layer of the present disclosure may comprise one or more colorants, including, for example, carmine, chlorophyll-metal complexes such as copper-chlorophyllin, turmeric, betanin, anthocyanins, beta-carotene, titan oxide, iron oxide, and/or any mixture thereof. Likewise, in some embodiments, an edible film and/or active layer of the present disclosure may comprise one or more sensory additives, which are included to improve and/or change the organoleptic properties of a pet food.

Meanwhile, in at least one embodiment, the edible film(s) and/or active layer(s) of the present disclosure comprise one or more component ingredients having a melting point of up to about from 95° C. In certain embodiments, an edible film of the present disclosure may comprise a wax having a melting point of between about 80 and about 95° C. And in some embodiments, the edible film may comprise fat lard and/or tallow with a melting point of between about 25 and about 75° C.

Furthermore, reaction products of the oxidation of fat have a negative influence on the flavour and aroma of a foodstuff, such as a pet food. The presence of those products, especially against the backdrop of their low flavour threshold, can lead to a pronounced reduction of the amount delivered, and may even result in the complete rejection of the product. High concentrations of those products, which may in particular be present in highly rancid animal food products, can even lead to diarrhea and vomiting in cats and dogs. Together with the effects on the animal, the rancid smell also causes annoyance for the pet owner.

In order to investigate the influence of the edible film and/or active layer on the storage stability of the pet food of the present disclosure, experiments were conducted under controlled conditions, especially in order to measure the peroxide and hexanal values. The tests were conducted under ambient conditions (not under accelerated conditions).

1.75 kg of a product which had been produced as described above and a control product (standard product) were stored in standardised containers under ambient conditions (240 C) for six months. In accordance with the experimental set-up summed up in Table 1 (below), the samples were examined at different times to determine their peroxide value and the quantity of hexanal. In this way, it was possible to obtain an estimate of the lipid oxidation.

TABLE 1
Protocol of storage under ambient conditions

| t(d) | 0 | 60 | 120 | 180 |
|---|---|---|---|---|
| Parameter | PV + hexanal | PV + hexanal | PV + hexanal | PV + hexanal |

Lipid hydroperoxides are the primary products of the lipid oxidation reaction. The hydroperoxides are therefore an important parameter for drawing conclusions regarding the degree of lipid oxidation in dry animal food. Hydroperoxides can be measured by titrimetrical methods, by which the peroxide value can be obtained. This expresses the concentration of hydroper-oxides as a milli-equivalent per kilogram of fat (meq/kg fat). The peroxide value (PV) is commonly used as a qualitative parameter for determining lipid oxidation in foodstuffs. It is used in particular to determine the rancidness and quality of dry animal food. Together with the hexanal content, it is the most suitable parameter for obtaining an estimate of the quality of an animal food of that kind.

The peroxide values were determined according to the AOCS method in the present case. The fat extracted was analysed using potentiometric methods by carrying out the titration step with a titrator and detecting the end point of the titration by means of an electrode.

Hexanal is an important secondary primary product of the lipid oxidation reaction. Together with the peroxide value, hexanal is therefore an important parameter for determining the degree of lipid oxidation in dry food. The level of the hexanal value was determined by head-space gas chromatography (HSGC), via which a hexanal concentration, expressed in ppm, is obtained. Hexanal is used as an additional qualitative parameter for determining the degree of lipid oxidation in dry animal food. In the course of a long-term storage test (as described) it is the most important parameter, together with the peroxide value, for being able to draw con-clusions about lipid oxidation.

Feeding experiments in order to assess the feeding or delivery performance were conducted as described in the following in order to be able to estimate differences in the feeding behaviour between the pet food of the invention and the reference products.

Experiments on the different feeding behaviour in dogs were conducted using pet food sam-ples based on dry food. The test was carried out with dogs of various breeds, especially small, medium-size and large breeds. The total number of dogs was 30. The samples were offered to the dogs twice a day for 20 minutes at a time in two different rotation systems, as illustrated in Table I. The amount of animal food offered was adjusted to the size of the dog concerned in each case.

TABLE
Rotation system for offering the samples

| Rotation A | | Rotation B | |
|---|---|---|---|
| A v. B | B v. A | B v. A | A v. B |

Products for the rest of the feeding were chosen carefully in order to balance out the ratio of texture, format and brands. The quantities consumed were calculated, and the results evalu-ated statistically.

In FIG. 2, the development of lipid oxidation for the pet food of the invention as described above is shown compared to a pet food in which any enrichment of copper sulphate in the active layer was dispensed with. PV here stands for the peroxide number/value (n=4). The experiments were conducted at room temperature. As can be seen from FIG. 2, enriching copper in the active layer in accordance with the invention resulted in distinctly improved stability against lipid oxidation.

The development of secondary oxidation products, expressed as the hexanal concentration (n=4), is shown in FIG. 3 for the same samples. In this case too, the experiments were conducted at room temperature.

FIGS. 4 and 5 show the results of dog feeding experiments (29 animals, two meals). Again, a comparison was made between the product manufactured according to the first worked embodiment and a comparative product, in which any enrichment of copper(II) sulphate in the active layer was dispensed with. It becomes clear that by using the pet food of the invention, a significant improvement in the product performance was achieved with regard to the preferred consump-tion by dogs.

Similarly, adding ascorbic acid in the active layer resulted in moderately improved stability against lipid oxidation. The development of lipid oxidation in a pet food having ascorbic acid added in an active layer versus a product with no such active layer, is shown in FIG. 7.

Further, the results of feeding tests for a pet food having ascorbic acid added in an active layer are illustrated in FIGS. 8 and 9. It was possible to show that adding ascorbic acid in the active layer led to a distinct improvement in the acceptance by dogs of the pet food obtained in this way.

The same conclusion can be drawn from the results shown in FIG. 10. Here too, PV stands for the peroxide number (peroxide value), with which the content of peroxide functional groups of a fat or fatty oil can be quantified. Specifically, FIG. 10 shows the development of lipid oxidation in a pet food having an edible film coated thereon, wherein the edible film comprises soy protein hydrolysate, pea starch, pork fat, lecithin, glycerol and water; and, as shown in FIG. 10, lipid oxidation is slowed considerably in such a pet food.

Accordingly, in some embodiments, the present disclosure is directed to a pet food comprising at least one edible film, wherein the edible film includes between 0.5 and 5% soy protein hydrolysate, between about 0.5 and 5% pea starch, between 0.5 and 5% pork fat, between about 0.1 and about 3% lecithin, between about 5 and about 10% glycerol and between about 70 and 95% water (in percent by weight, based on the total volume of the coating mixture). Moreover, in particular embodiment, the present disclosure provides a pet food comprising an edible film that includes between about 1 and 4% soy protein hydrolysate, between about 1 and 4% pea starch, between 1 and 4% pork fat, between about 0.5 and about 2.5% lecithin, between about 6 and about 9% glycerol and between about 75 and 90% water (in percent by weight, based on the total volume of the coating mixture). These embodiments may optionally additionally comprise any other ingredient disclosed or described herein.

In a specific example, the present disclosure provides a pet food having an edible film comprising about 2.5% soy protein hydrolysate, about 2.5% pea starch, about 2.5% pork fat, about 1.3% lecithin, about 7.5% glycerol, and about 83.7% water.

And in some embodiments, the present disclosure provides a pet food having an edible film comprising, in percent by weight, based on the total volume of the coating mixture, between about 1 and 5% whey protein isolate, between about 1 and 5% pea starch, between about 1 and about 5% carnauba wax, between about 5 and 10% glycerol, between about 0.5 and 2% soya lecithin, and between about 0.25 and 1.25% copper (II) sulphate.

In a specific example, a coating mixture was used which contained (in percent by weight, based on the total volume of the coating mixture) 2.5% whey protein isolate, 2.5% pea starch, 2.5% carnauba wax, 7.5% glycerol, 1.3% soya lecithin and 0.84% copper(II) sulphate.

The features of the invention(s) disclosed in the above description, in the claims and in the drawings can be essential to implementing the invention in its various embodiments both individually and in any combination.

It will be understood that various details of the presently disclosed subject matter can be changed without departing from the scope of the subject matter disclosed herein. Furthermore, the foregoing description is for the purpose of illustration only, and not for the purpose of limitation.

1. A pet food comprising:
a) a pet food core;
b) an active layer surrounding the pet food core, wherein the active layer comprises a pro-oxidant mineral; and
c) an outer layer surrounding the active layer, wherein the outer layer comprises a fat and/or a palatant,
wherein the active layer is enriched with the pro-oxidant mineral compared to the pet food core.

2. The pet food of claim 1, wherein the pet food core is a dry pet food core, a semi-moist pet food core, or a care & treat pet food core.

3. The pet food of claim 1, wherein the pro-oxidant mineral comprises pro-oxidant metal ions.

4. The pet food of claim 1, wherein the pro-oxidant mineral is contained in the active layer in an amount of 0.0001-0.011% (w/w) based on the total weight of the pet food.

5. The pet food of claim 1, wherein the active layer further comprises a protein compound, a carbohydrate compound, a fat compound and/or a wax, a plasticiser, an emulsifier, or mixtures thereof.

6. (canceled)

7. A pet food, comprising:
a) a pet food core,
b) an active layer surrounding the pet food core, wherein the active layer comprises an antioxidant compound, and
c) an outer layer surrounding the active layer, wherein the outer layer comprises a fat and/or palatant,
wherein the pet food core and the active layer have different total concentrations of antioxidant compounds and/or the pet food core and the active layer comprise different antioxidant compounds and/or the same antioxidant compounds in different concentrations.

8. The pet food of claim 7, wherein the antioxidant compound is selected from the group consisting of ascorbic acid, ascorbic acid ester, tocopherol (α,β,γ and δ-tocopherol), Trolox, propyl galate, resveratrol, butyl hydroxyanisol, tert-butyl hydroxytoluene, veg-etable polyphenols, anthocyanins, proanthocyanidins, caffeic acid, chlorogenic acid, ferulic acid, lycopenes, carotenoids, and mixtures thereof.

9. The pet food of claim 7, wherein the pet food core is a dry food core, a semi-moist pet food core, or a care & treat product.

10. The pet food as of claim 7, wherein the antioxidant compound is contained in the active layer in an amount of 0.015-0.6% (w/w), the carbohydrate compound in an amount of 0.015-0.6% (w/w), the fat compound and/or the wax in an amount of 0.015-0.6% (w/w), the plasticiser in an amount of 0.015-1.2% (w/w), and the emulsifier in an amount of 0.03-0.6% (w/w), based on the total weight of the pet food.

11. The pet food of claim 7, wherein the active layer further comprises a protein compound, a carbohydrate compound, a fat compound and/or a wax, a plasticiser, an emulsifier or mixtures thereof.

12. (canceled)

13. The pet food of claim 7, wherein the active layer further comprises an amount of curcumin.

14-15. (canceled)

16. A method of increasing the shelf life of a pet food having a pet food core, comprising:
providing a pet food core;
coating the pet food core with a first edible film, wherein the first edible film comprises at least one antioxidant; and
coating the pet food core that includes the first edible film with at least one outer layer, wherein the other layer comprises a fat, a palatant, or both a fat and a palatant.

17. The method of claim 16, further comprising, prior to the step of coating with at least one out layer, coating pet food core that includes the first edible film with a second edible film that comprises at least one pro-oxidant.

18. The method of claim 16, wherein a the first edible film and the at least one outer layer at least partially surrounds the pet food core.

19. (canceled)

20. The pet food of claim 1, wherein the active layer further comprises a component selected from the group consisting of whey protein hydrolysate, pea starch, carnauba wax, glycerol, soya lecithin, and mixtures thereof.

21. The pet food of claim 1, wherein the active layer further comprises a component selected from the group consisting of soy protein hydrolysate, pea starch, pork fat, lecithin, glycerol, water, and mixtures thereof.

22. The pet food of claim 3, wherein the pro-oxidant mineral comprises copper, iron, cobalt, manganese salts, or mixtures thereof.

23. The pet food of claim 3, wherein the pro-oxidant mineral comprises Cu(I), Cu(II), Fe(II), Fe(III), Co(III), or mixtures thereof.
